(19) United States
(12) Patent Application Publication
(10) Pub. No.: US 2012/0011100 A1
(43) Pub. Date: Jan. 12, 2012

(54) SNAPSHOT ACQUISITION PROCESSING TECHNIQUE

(75) Inventors: Yasuo YAMANE, Kawasaki (JP); Yuichi Tsuchimoto, Kawasaki (JP); Toshiaki Saeki, Kawasaki (JP); Hiromichi Kobashi, Kawasaki (JP)

(73) Assignee: FUJITSU LIMITED, Kawasaki (JP)

(21) Appl. No.: 13/115,269

(22) Filed: May 25, 2011

(30) Foreign Application Priority Data
Jul. 6, 2010 (JP) 2010-153742

(51) Int. Cl. G06F 17/30

(52) U.S. Cl. 707/649; 707/E17.007

(57) ABSTRACT

This method includes, in response to receipt of a snapshot request from a first node that receives an instruction to obtain a snapshot, identifying transactions in progress; transmitting data representing states of the identified transactions in progress to the first node; after the identifying, carrying out a first processing to prevent the transactions in progress from normally completing; receiving a list of first transactions whose results are reflected to snapshot data or a list of second transactions whose results are not reflected to the snapshot data; and executing copy-on-write on a basis of a specific time after removing the first transactions from among transactions to be processed in the first processing and confirming that the respective first transactions are normally completed or cancelled.

### CROSS-REFERENCE TO RELATED APPLICATIONS

This application is based upon and claims the benefit of priority of the prior Japanese Patent Application No. 2010-153742, filed on Jul. 6, 2010, the entire contents of which are incorporated herein by reference.

### FIELD

This technique relates to a technique for distributedly holding data in plural nodes.

### BACKGROUND

In the sphere of cloud computing, large-scale data is stored and processed in a large-scale distributed system (about hundred to tens of thousands of computers are integrated with a network). This kind of system is called, for example, a distributed data store. Such distributed data store has higher scalability and fault tolerance than a distributed database, which is a system resulting from distributing a typical relational database (RDB). However, in the current stage, functionally, the distributed data store is still no match for the RDB. Hereafter, the distributed data store and distributed database will be called a “distributed data system”.

In this kind of distributed data system, acquiring a snapshot (in other words, a copy of the entire data at a certain time) is considered. Because the snapshot is a copy at a certain time, the snapshot is typically not the most recent except for right after the acquiring. However, the snapshot is useful when desiring to see information going back in time to the certain time. Moreover, when performing a summing processing in which all data is referenced in a system in which updates occur often, there is a possibility of coming into collision with the processing by another user. However, because the snapshot does not cause any updates, other processing can be carried out without any collision with the snapshot. In a processing that uses the snapshot, data that is not the most recent is often sufficient. Therefore, it is unnecessary to worry much about the most recent data. However, consistency of data must be maintained.

For example, when acquiring a snapshot while a transaction is in progress, there is a possibility that consistency will be lost. Therefore, there is a problem when a transaction is carried out in plural nodes that are included in the distributed data system. More specifically, as illustrated in FIG. 1, a transaction t1 of transferring 1 million dollars from account A to account B is carried out across node 1 and node 2. In other words, a sub-transaction t1-1 is executed at the node 1, and a sub-transaction t1-2 is executed at the node 2. Here, a snapshot S1 is obtained at the node 1 before the transaction t1, and obtained at the node 2 after the transaction t1. As a result, an amount of 3 million dollars for the account A and account B is included in the snapshot, and the overall amount is increased by an amount of 1 million dollars. In this way, a snapshot that does not have consistency becomes a problem in the summing processing and/or analysis processing.

As for a snapshot, a method called copy-on-write may be used. The copy-on-write virtually makes a show that a copy has been obtained, and at writing that is performed later (in other words, at executing “write” command), the values before the writing are copied. In a core system in which updates are carried out frequently, when the summing processing and/or analysis processing that uses the snapshot is executed at the same time, there is a high possibility that the collision will occur. However, because, by using the copy-on-write, it appears that the processing to acquire the snapshot is completed immediately, both of the processing can be executed simultaneously without any collision. However, how the copy-on-write should be used in a situation in which a transaction is executed across the plural nodes as described above was not taken into consideration before.

Namely, when data is distributedly held in plural nodes of a system such as the distributed data system, it is difficult for conventional arts to obtain the consistent snapshot.

### SUMMARY

An information processing method relating to a first aspect of this technique includes: in response to receipt of a snapshot request from a first node that receives an instruction to obtain a snapshot, identifying transactions in progress; transmitting data representing states of the identified transactions in progress to the first node; after the identifying, carrying out a first processing to prevent the transactions in progress from normally completing; receiving a list of first transactions whose results are reflected to snapshot data or a list of second transactions whose results are not reflected to the snapshot data; and causing to execute copy-on-write on a basis of a specific time after removing the first transactions from among transactions to be processed in the first processing and confirming that the respective first transactions are normally completed or cancelled.

In addition, an information processing method relating to a second aspect of this technique includes: in response to receipt of an instruction to obtain a snapshot, transmitting a snapshot request to each of a plurality of first nodes; receiving, from each of the plurality of first nodes, identifiers of transactions in progress and data representing states of the transactions in progress, and storing the received identifiers and the received data into a data storage unit in association with a transmission source node; identifying first transactions for which an acknowledgement response has been outputted in each of relating transmission source nodes from among the transactions whose identifiers are stored in the data storage unit; and transmitting a list of the identified first transactions or a list of second transactions that are transactions other than the identified first transactions among the transactions whose identifiers are stored in the data storage unit.

The object and advantages of the embodiment will be realized and attained by means of the elements and combinations particularly pointed out in the claims.

It is to be understood that both the foregoing general description and the following detailed description are exemplary and explanatory and are not restrictive of the embodiment, as claimed.

### BRIEF DESCRIPTION OF DRAWINGS

FIG. 1 is a diagram to explain a problem in a distributed data system;

FIG. 2 is a functional block diagram of a system relating to a first embodiment;

FIG. 3 is a diagram depicting a processing flow relating to the first embodiment;

FIG. 4 is a functional block diagram of a distributed data system relating to a second embodiment;

FIG. 5 is a diagram to explain the two-phase commit protocol;

FIG. 6 is a diagram depicting the relationship between the distributed transactions and the two-phase commit protocol;

FIG. 7 is a diagram to explain an outline of a processing in the second embodiment;

FIG. 8 is a diagram depicting an example of a management table stored in a data storage unit of a participant node;

FIG. 9A is a diagram depicting a snapshot protocol in the second embodiment;

FIG. 9B is a diagram to explain output delay of an acknowledgement response and commit;

FIG. 10 is a diagram depicting a processing flow in the second embodiment;

FIG. 11 is a diagram to explain a list of transactions in progress;

FIG. 12 is a diagram schematically depicting transaction progress states in node A;

FIG. 13 is a diagram schematically depicting transaction progress states in node B;

FIG. 14 is a diagram depicting an example of data stored in a data storage unit in a coordinator node;

FIG. 15 is a diagram depicting a processing flow of a transaction selection processing;

FIG. 16 is a diagram schematically depicting selection reference in case of two nodes;

FIG. 17 is a diagram depicting selected transactions incase of FIGS. 12 and 13;

FIG. 18 is a diagram depicting an example of a list of selected transactions;

FIG. 19 is a diagram depicting a processing flow in the second embodiment;

FIG. 20 is a diagram depicting a processing flow of a selected transaction processing;

FIG. 21 is a diagram depicting an example of a selected transaction management table;

FIG. 22 is a diagram to explain update of database and update of a snapshot file;

FIG. 23 is a diagram depicting a processing flow for a processing to obtain snapshot data;

FIG. 24 is a functional block diagram of a computer;

FIG. 25 is a diagram to explain the three-phase commit protocol; and

FIG. 26 is a diagram to explain the basic copy-on-write.

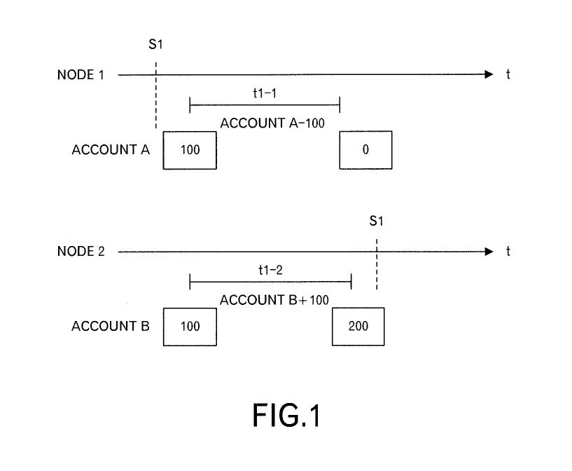

### DESCRIPTION OF EMBODIMENTS

### Embodiment 1

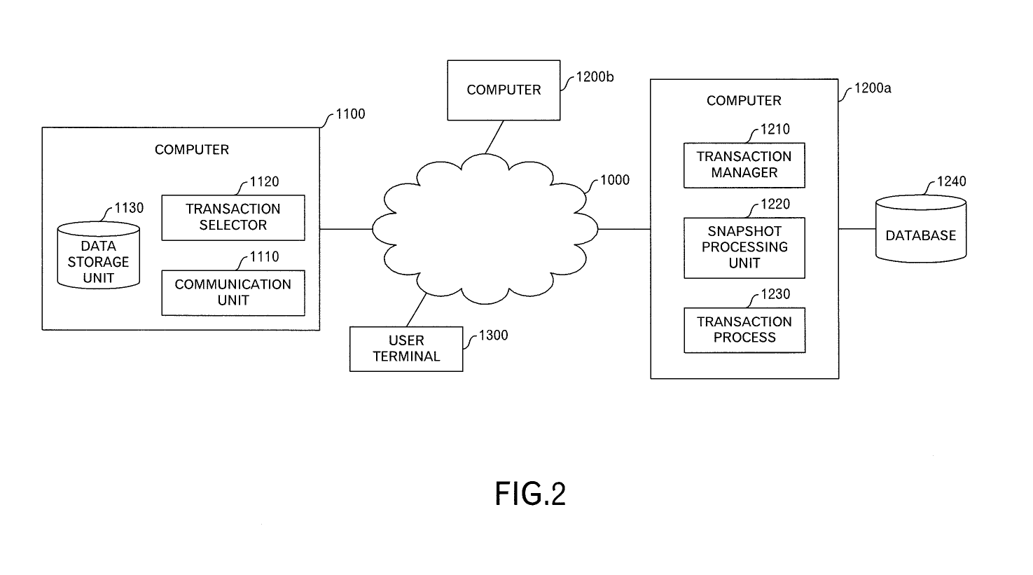

FIG. 2 illustrates a configuration of a system relating to this embodiment. In this system, a user terminal 1300, a computer 1100 (may be called “snapshot coordinator computer”) that carries out the management for the snapshot, and plural computers 1200 (may be called “snapshot participant computer”) (1200a and 1200b in FIG. 2. The number of computers 1200 is not limited to two) that acquire the snapshot in response to a request to obtain the snapshot from the computer 1100 are connected with a network 1000. The computer 1100 has a communication unit 1110, a transaction selector 1120 and a data storage unit 1130. On the other hand, the computer 1200 has a snapshot processing unit 1220, a transaction manager 1210 and a database 1240 that stores various kinds of data. Incidentally, the computer 1200 generates and executes a transaction process 1230 for performing various transactions with respect to the database 1240 as necessary.

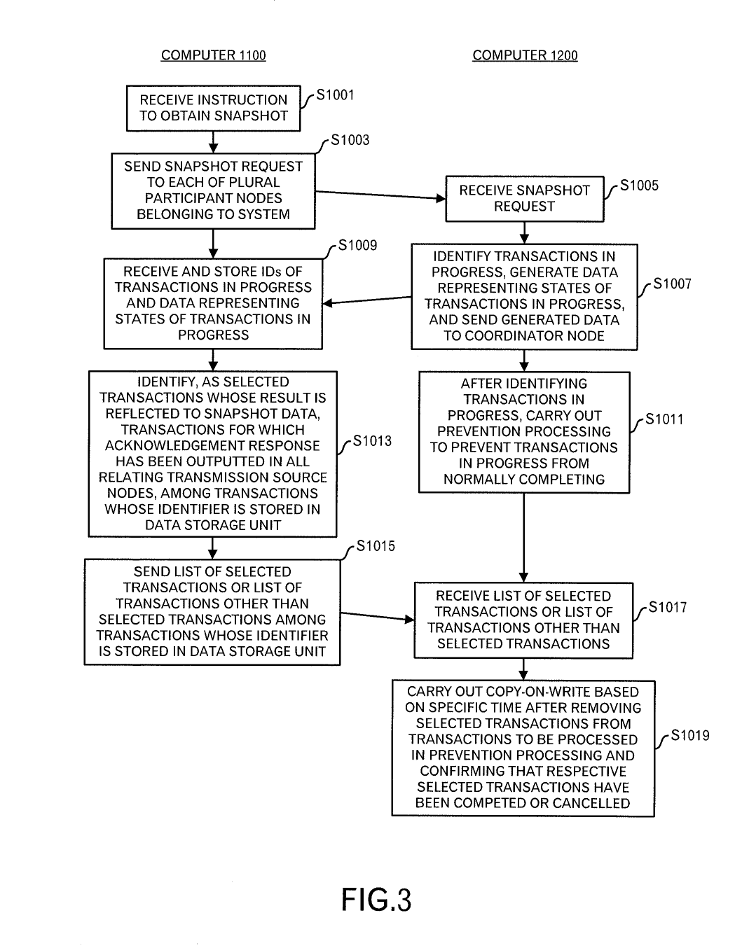

The system illustrated in FIG. 2 is explained using FIG. 3. First, the communication unit 1110 of the computer 1100 receives an instruction to obtain the snapshot from a user terminal 1300 connected with the network 1000 (step S1001). Then, the communication unit 1110 of the computer 1100 transmits a snapshot request to each of plural participant nodes, or in other words each of plural computers 1200 that are nodes from which the snapshot should be obtained (step S1003).

In response to the request, the snapshot processing unit 1220 of the computer 1200 receives the snapshot request from the computer 1100 (step S1005). Then, the transaction manager 1210 of the computer 1200 identifies transactions in progress (for example, transaction process 1230) in the computer 1200, generates data representing the states of the transactions in progress, and outputs the generated data to the snapshot processing unit 1220. The snapshot processing unit 1220 transmits identifiers of the transactions in progress and data representing the states of the transactions in progress to the computer 1100 (or in other words, the coordinator node) (step S1007).

Furthermore, after identifying the transaction in progress, the transaction manager 1210 carries out a prevention processing to prevent the transactions in progress from normally completing (step S1011). As for the transactions other than selected transactions that will be described later, the normal completion of the transaction is delayed so that the results of the transactions are not reflected to the snapshot. However, at this step, the selected transactions whose results are reflected to the snapshot and other transactions whose results are not reflected to the snapshot have not yet been identified. Therefore this step is uniformly executed for the transactions under operation in order that the transactions do not complete properly.

The communication unit 1110 of the computer 1100 receives the identifiers of the transactions in progress and the data representing the states of the transactions in progress from each of the computers 1200, stores the received identifiers of the transactions in progress and the received data into the data storage unit 1130 in association with the transmission source computer 1200 (step S1009).

After the aforementioned data is received from all of the computers 1200, the transaction selector 1120 identifies, from among the transactions whose identifier is stored in the data storage unit 1130, transactions for which an acknowledgement response (in other words, “ack”) has been outputted in each relating transmission source participant nodes (in other words, computers 1200) as selected transactions whose results are reflected to snapshot data (step S1013). That is because, when an acknowledgement response has been outputted from all of the transmission source participant nodes, the transactions complete normally with no delay or are cancelled. Therefore, it is preferable that the results of such transactions are included into the snapshot in view of securing the immediacy of the snapshot. As for transactions for which an acknowledgement response is not outputted from all of the transmission source participant nodes, the time until the transactions complete normally or are cancelled is highly uncertain, and when trying to include the results of the transactions into the snapshot, the snapshot acquisition timing is delayed by that uncertain amount of time. Therefore, it is considered that the results of such transactions may not be included into the snapshot. Then, the communication unit 1110 transmits a list of selected transactions, or a list of the transactions other than the selected transactions among the transactions whose identifiers are stored in the data storage unit 1130 to each of the computers 1200 (step S1015).

In response to the transmission of the list, the snapshot processing unit 1220 in each of the computers 1200 receives the list of the selected transactions or the list of transactions that are transactions other than the selected transactions from the computer 1100 (step S1017). Incidentally, the list of the selected transactions may be a list that is common for all of the computers 1200, or may be an individual list for each of the computers 1200. The individual list may include a list of the selected transactions relating to the computer 1200 that is a destination of the individual list, and may also not include a list of transactions that are not to be processed by the destination computer 1200.

Then, the transaction manager 1210 removes the selected transactions (this typically includes one or plural transactions, however there is a case that no transaction are included, namely a case of “empty”) from the transactions for which the prevention processing is carried out, and the snapshot processing unit 1220 causes to execute the copy-on-write on a basis of a specific time T after the respective selected transactions has normally been completed or cancelled (step S1019). In other words, as for a transaction that completed normally before the time point T, when the data after the processing of the transaction has completed is updated after the time point T, a processing (copy-on-write) for saving the data before the update is executed. Therefore, the states of the data after the processing of the transaction are recorded as the snapshot. Incidentally, the selected transactions have consistency among all of the computers 1200, so that when a transaction is the selected transaction in a certain computer 1200, there is no contradiction of it not being the selected transaction in another computer 1200. Such consistency is also the same for transactions that are not selected transactions.

On the other hand, the processing to prevent from normally completing is carried out for the transactions other than the selected transactions to control the timing of the completion of the transactions so that the transactions do not complete normally before the time point T described above, and so that the normal completion of the transactions is made after the time point T has passed. As a result, when data update is caused by the normal completion of the transactions after the time point T has passed, the copy-on-write (data copy before the update) is performed immediately. Therefore, as for the transactions other than the selected transactions, the data before the transaction completes normally is included into the snapshot, and the processing result of such a transaction is not reflected on the snapshot.

As described above, by properly categorizing transactions according to the states of the transactions, and adjusting the time point of the commit, adjustment is made in order to avoid the lack of consistency, such as the result of a transaction T1 being reflected onto the snapshot at a certain node, however, no result being reflected onto the snapshot at another node.

### Embodiment 2

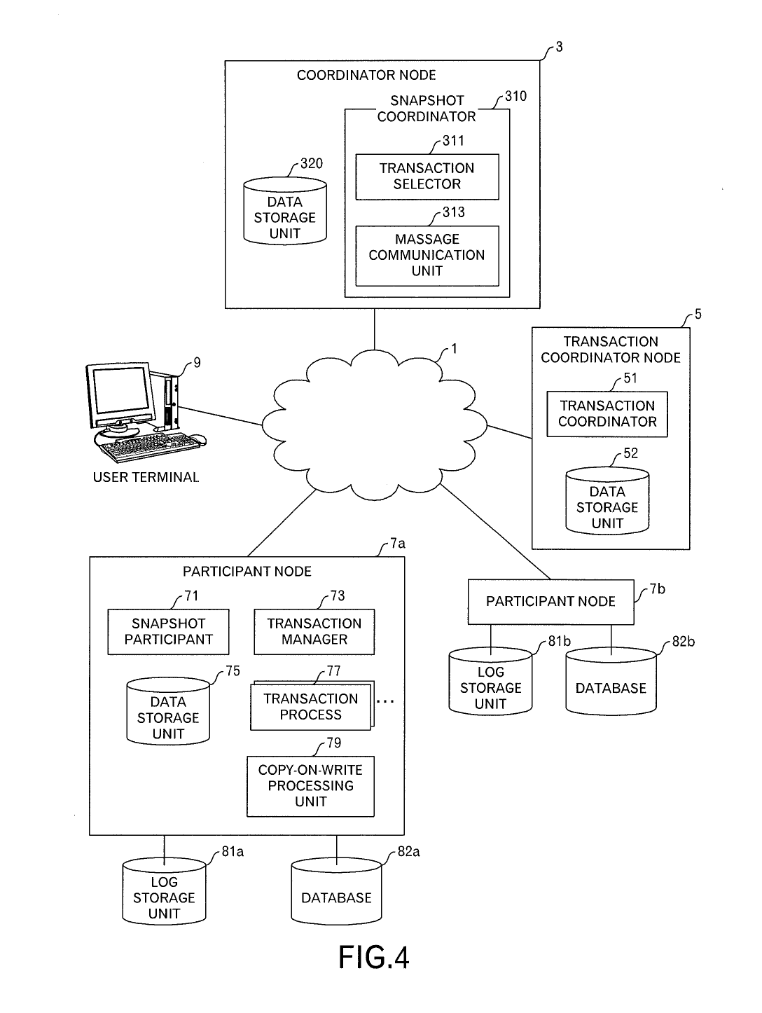

FIG. 4 illustrates a system configuration of a distributed data system in this embodiment. For example, a coordinator node 3 that coordinates the snapshot, a transaction coordinator node 5 that coordinates the distributed transactions, and plural participant nodes 7 (7a and 7b in the figure, however, the number of nodes is not limited to two, and there may be many nodes.) that carries out one or plural distributed transactions, and cooperates with the coordinator node 3 to carry out a processing to obtain the snapshot, and a user terminal 9, such as a personal computer, are connected to a network 1 such as an in-house LAN (Local Area Network) or the Internet.

The coordinator node 3 has a snapshot coordinator 310, and a data storage unit 320 that stores data that is processed by that snapshot coordinator 310. The snapshot coordinator 310 has a transaction selector 311 and a message communication unit 313.

The transaction coordinator node 5 has a transaction coordinator 51 and a data storage unit 52.

The participant node 7 has a snapshot participant 71 that cooperates with the snapshot coordinator 310, a transaction manager 73 that cooperates with the transaction coordinator 51, a transaction process 77 that is generated from the transaction manager 73 and functions as a transaction participant, a data storage unit 75 that stores data that is processed by the transaction manager 73 and snapshot participant 71, and a copy-on-write processing unit 79 that performs a processing for the copy-on-write. In addition, the participant node 7 also manages a database 82 that is processed by a transaction (in FIG. 4, database 82a in the participant node 7a, and database 82b in the participant node 7b), and a log storage unit 81 that stores transaction log (in FIG. 4, log storage unit 81a in the participant node 7a, and log storage unit 81b in the participant node 7b). Incidentally, the transaction process 77 is a process that the transaction manager 73 generates as necessary in response to receipt of an instruction from the transaction coordinator 51. In addition, the database 82 includes not only a typical RDB, but also includes an apparatus that simply stores data.

The transaction coordinator node 5 may also sometimes be a participant node 7. In other words, the transaction coordinator 51 may also sometimes be included in the participant node 7. Similarly, the coordinator node 3 may also sometimes be a participant node 7. In other words, the snapshot coordinator 310 may also sometimes be included in the participant node 7. However, in the following, in order to simplify the explanation, they will be explained as being included in a separate node.

First, a few basic items of this embodiment will be explained.

In this embodiment, the term “transaction” is one of terms in database terminology, and indicates a group of processes that have consistency. For example, in a bank transfer, a processing to transfer a certain amount of money from one account to another account corresponds to one transaction. When there is consistency in the state before execution of the transaction, there is consistency also after execution of the transaction. In terms of the example above, there is consistency in that the total amount of money does not change even after execution of the transaction. In this embodiment, a transaction across plural nodes is called a distributed transaction. Moreover, when noted as a transaction, this also includes transactions within one node, and distributed transactions.

The transaction is processed as all or nothing. For example, in case of transferring a certain amount of money from one account to another account in the wire transfer, when an error occurs during the transaction, the data is not left in an unfinished state, and finally all of the data are reflected (commit) or all processes are cancelled (abort). Otherwise, inconsistency occurs.

Typically, the update results in a transaction are stored into a temporal storage area such as the log storage unit 81, and at the commit, the update results are finally reflected to the actual storage location of the data system, such as the database 82. On the other hand, at the abort, the update results that were written in the log are discarded.

Furthermore, in the distributed transaction, the execution that is processed at each node is called a sub-transaction. However, when it is known that the sub-transaction is executed at a specific node, such sub-transaction is also called a transaction. In the distributed data system, plural transactions may be processed simultaneously in the entire system. Therefore, there is a possibility that plural sub-transactions are operating at each node. In the distributed transaction, when there is even one sub-transaction to be aborted, all of the sub-transactions must also be aborted. In the case that even one sub-transaction is committed, inconsistency will occur. Therefore, the transaction coordinator 51 manages all of the sub-transactions together. In this embodiment, even when there is only one sub-transaction in the distributed transaction, similar control is made.

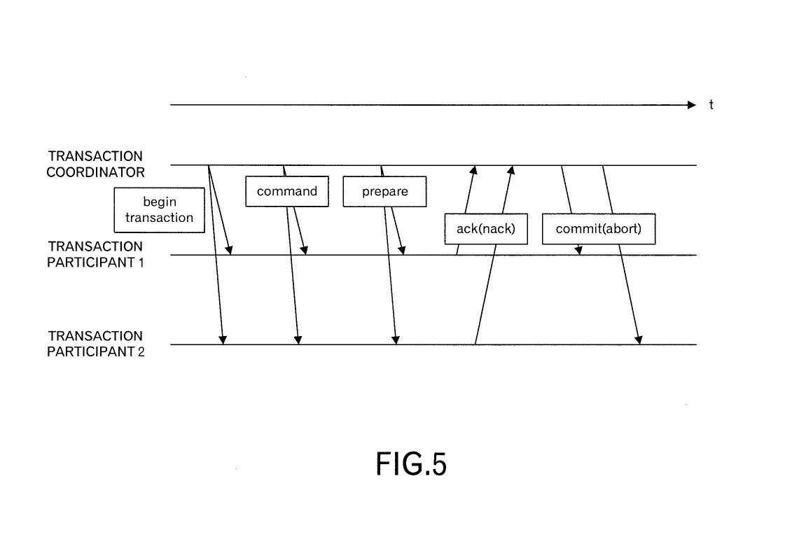

As described above, in the distributed transaction, when some of the sub-transactions are committed and the remaining are aborted, the consistency is lost. In order that such a case does not occur and the consistency is maintained, there is a two-phase commit protocol as illustrated in FIG. 5 as a protocol for performing control so that the sub-transactions relating to the distributed transaction are either all committed or all aborted. In this embodiment, the distributed transaction follows a protocol such as this two-phase commit protocol (including three-phase commit protocol that will be described later) to synchronize with each other to carry out the commit, by finally exchanging messages of ack (called an acknowledgement response) and commit. A commit protocol having these characteristics is simply called a commit protocol in the following.

The transact ion participant illustrated in FIG. 5 is a process executing a sub-transaction of the distributed transaction at each node, or a process executing a transaction within one node, and is illustrated as the transaction process 77 in FIG. 4. The transaction coordinator is a process to control one or more transaction participants relating to one transaction through the two-phase commit protocol, and is illustrated as the transaction coordinator 51 in FIG. 4. The transaction coordinator and transaction participant are generated as separate processes for each transaction.

As illustrated in FIG. 5, in the two-phase commit protocol, after the transaction coordinator outputs a “begin transaction” and the transaction participants 1 and 2 are generated, the transaction coordinator transmits a “command” to the transaction participants 1 and 2, and causes them to execute the processing. After that, the transaction coordinator transmits a “prepare” to inquire whether or not a commit is possible to the transaction participants 1 and 2. When the commit is possible, the transaction participants 1 and 2 transmit an acknowledgement response (ack), and when the commit is not possible, the transaction participants 1 and 2 transmit a negative acknowledgement response (nack). When an acknowledgement response is obtained from all of the transaction participants, the transaction coordinator transmits a commit to the transaction participants 1 and 2. When even one transaction participant returns a negative acknowledgement response (nack), the transaction coordinator transmits an abort to all of the transaction participants.

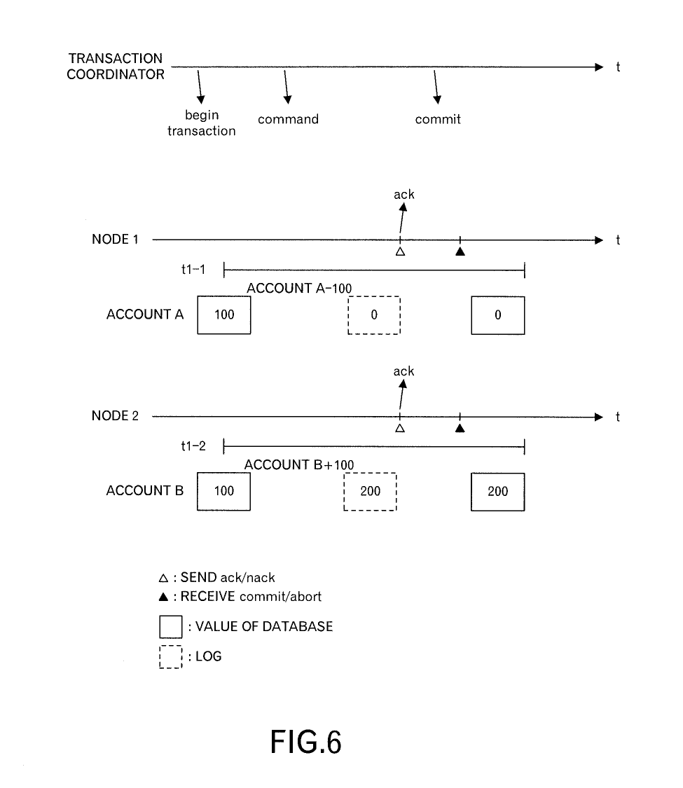

FIG. 6 illustrates an example of the relationship between the distributed transaction and two-phase commit protocol. In this example, the transaction coordinator generates transaction participant processes that execute sub-transactions t1-1 and t1-2 at nodes 1 and 2 by the “begin transaction”, and gives an instruction to cause them to execute a processing of transferring “100” from an account A to an account B by the “command”. Here, in the sub-transaction t1-1 in the node 1, the balance “100” of the account A is reduced to “0” in the log, and in the sub-transaction t1-2 at the node 2, the balance “100” of the account B is increased to “200” in the log, after which acknowledgement responses (ack) are transmitted to the transaction coordinator. Then, the transaction coordinator transmits a commit to the transaction participant of the sub-transaction t1-1 at the node 1, and the transaction participant of the sub-transaction t1-2 at the node 2. As a result, the transaction participants of the sub-transactions at the respective nodes update the database according to the log, and complete their own processing.

The distributed transaction in this example is an example in which the transaction is committed at the nodes 1 and 2, and the consistency is maintained. As illustrated in FIG. 6, after all of the update processes of the transaction have completed and the results have been written into the log, or in other words, after reaching a state that any processing for either a commit or abort can be made, an acknowledgement response (ack) is transmitted to the transaction coordinator. After receiving a commit from the transaction coordinator, each transaction participant reflects the results written in the log onto the database.

When any processing up to writing the update result into the log was not successful, a negative acknowledgement response (nack) is returned. Even in the case where there is just one negative acknowledgement (nark), the transaction coordinator transmits an abort, and the transaction is aborted.

Before transmitting the acknowledgement response (ack) message, a log representing that this acknowledgement response is transmitted is written into the log data storage unit. Also, immediately after the commit message is received, a log representing that the commit has been received is written into the log data storage unit. This is carried out so that, in the case some kind of trouble occurs after that, it is possible to know the transaction state and restore the transaction.

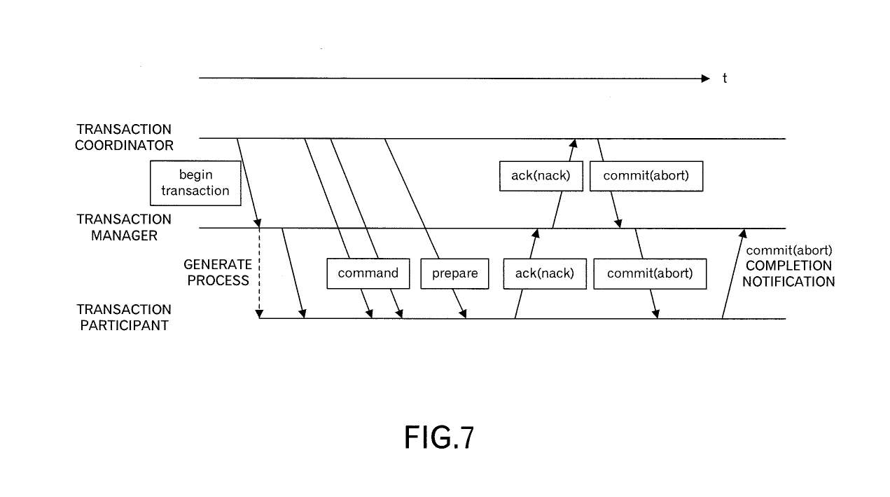

Next, the outline of the processing flow of the system illustrated in FIG. 4, which is based on the two-phase commit protocol, will be explained using FIG. 7 to FIG. 9B. FIG. 7 illustrates the relationship among the transaction manager 73, transaction coordinator 51 and transaction participant (or in other words, transaction process 77) in this embodiment.

The transaction coordinator 51, as described above, transmits a “begin transaction” to nodes (here, the transaction participant node 7) that will execute a sub-transaction. This is the same as normal.

The transaction manager 73 manages and controls the transaction (more precisely, the sub-transaction) in the participant node 7, and the transaction manager 73 captures the “begin transaction” from the transaction coordinator 51, generates a process for a transaction participant, and further transmits the “begin transaction” to the transaction participant. After this, the transaction coordinator 51 transmits “command” and “prepare” messages to the transaction participant, and the transaction participant receives the “command” and “prepare” messages without the transaction manager 73 taking part in the exchange of this kind of messages. In response to this, the transaction participant outputs an acknowledgment response (ack) or negative acknowledgement response (nack). The transaction manager 73 captures this response. Incidentally, in the case of a situation as will be described below, transmission of the acknowledgement response to the transaction coordinator 51 is delayed. Similarly, in response to the acknowledgement response or negative acknowledgement response, the transaction coordinator 51 transmits a commit or abort, and the transaction manager 73 captures that message. In the case of a situation as described below, output of the commit to the transaction participant is delayed.

In this embodiment, after a log representing that a commit or abort was received has been written, the transaction participant outputs a commit completion notification or abort completion notification to the transaction manager 73. After that, in the case of the commit, the transaction participant reflects the processing result to the database 82. Incidentally, after the processing result has been reflected onto the database, or after the processing for the abort has been completed, a commit completion notification or abort completion notification may be outputted. However, as described above, there is no problem even when the notification is transmitted after writing the log, and this is advantageous because the notification is made earlier. As a result of this, the transaction manager 73 knows that the processing on the transaction participant side is complete.

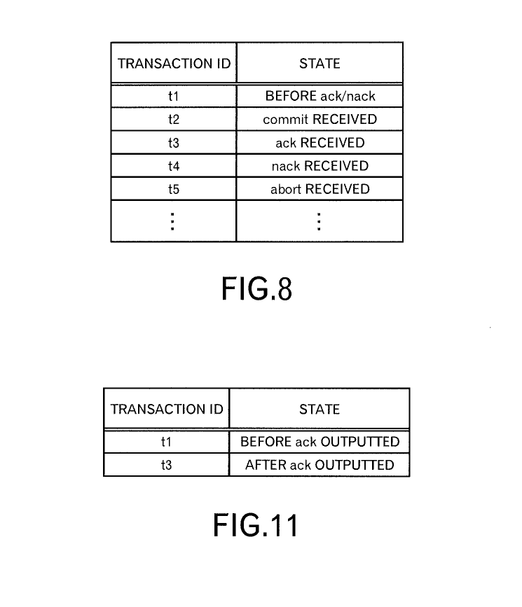

In this way, the transaction manager 73 manages the transaction (in other words, sub-transaction) in progress at the participant node 7, and grasps the processing state. For example, data such as illustrated in FIG. 8 is stored in the data storage unit 75. In the example in FIG. 8, the state is registered for each transaction ID. The state includes, for example, “before ack/nack”, “commit received”, “ack received”, “nack received” and “abort received”. As will be explained below, whether or not the transaction manager 73 has received an acknowledgement response (ack), or in other words, whether or not the transaction participant has output an acknowledgement response (ack) is a state that must be paid attention on the categorization of the transaction.

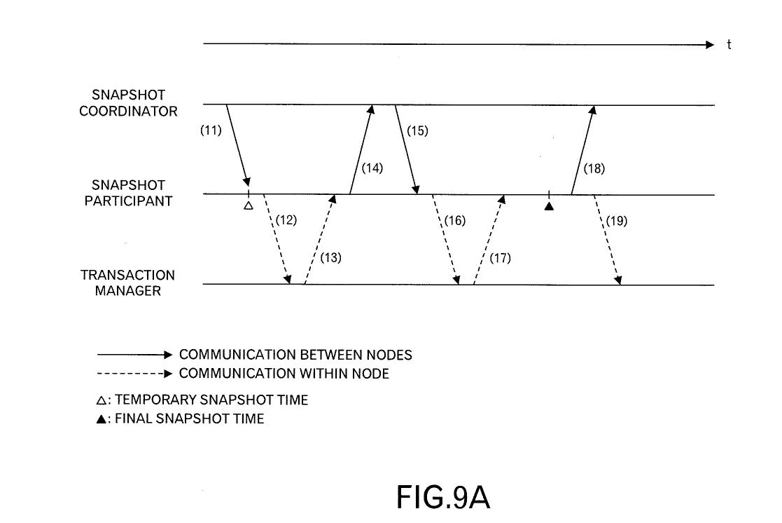

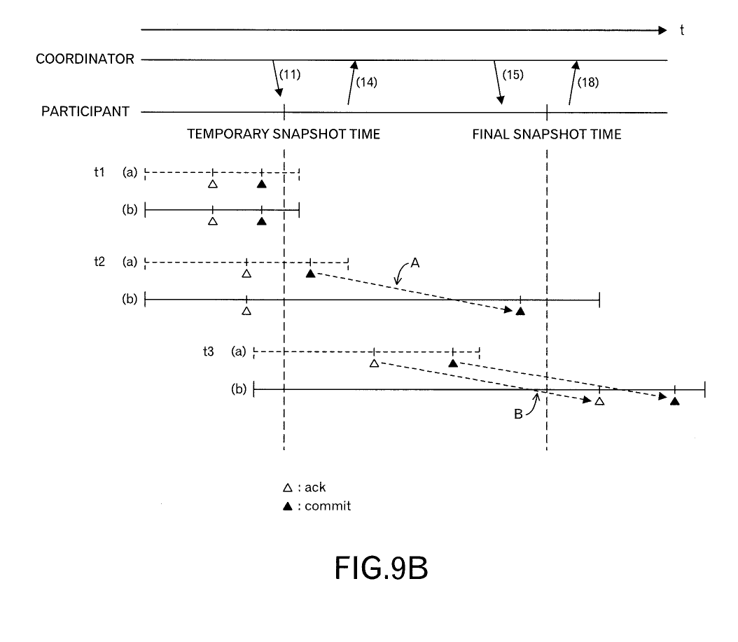

Next, the snapshot protocol will be explained using FIG. 9A. The protocol used between nodes in order to obtain the snapshot in the distributed data system is called “snapshot protocol”. The snapshot coordinator 310 receives an instruction to obtain the snapshot from a user terminal 9, for example, and transmits a snapshot request to all of the participant nodes 7 (step (11)). The snapshot participant 71 of the participant node 7 receives the snapshot request, after which a temporary snapshot time is determined. The temporary snapshot time is the time at which the transactions in progress are fixed, however, the snapshot is not necessarily acquired at this time. Therefore, this time is a mere “temporary snapshot time”.

Here, the snapshot participant 71 outputs a request for a list of transactions in progress to the transaction manager 73 (step (12)). The transaction manager 73 identifies the transactions in progress according to a predetermined rule, generates a list of transactions in progress and outputs the generated list to the snapshot participant 71 (step (13)). As will be explained below, after the transactions in progress have been identified, the transaction manager 73 captures the acknowledgement responses and commits for the transactions listed in the list of transactions in progress and delays the output thereof.

The snapshot participant 71 receives the list of the transactions in progress from the transaction manager 73, and transmits the list to the snapshot coordinator 310 of the coordinator node 3 (step (14)). The snapshot coordinator 310 receives the list of the transactions in progress from all of the participant nodes 7, then performs a processing as will be described below to select the transactions whose results will be reflected onto the snapshot, generates a list of selected transactions for each participant node, and transmits the generated list to each participant node 7 (step (15)). The selected transactions are transactions for which an acknowledgement response (ack) has been outputted at all of the relating nodes.

The snapshot participant 71 of the participant node 7 receives the list of the selected transactions, and then outputs the list of the selected transactions to the transaction manager 73 (step (16)).

The transaction manager 73 receives the list of the selected transactions, and carries out a processing for the commit or abort for the transactions listed in the list of the selected transactions. In other words, the transaction manager 73 transmits the captured acknowledgement responses and outputs the commit. Incidentally, as for the abort, transmission is not delayed, so a processing is completed as is with failure of the transaction, however, that the abort was transmitted (or received) is checked.

After writing into the data storage unit 75 that the commit or abort was received, each of the selected transaction participants outputs a commit completion notification or abort completion notification to the transaction manager 73. After that, when the commit completion notification or abort completion notification has been received from all of the transactions listed in the list of selected transactions, the transaction manager 73 outputs a notification to notify the completion of a selected transaction processing to the snapshot participant 71 (step (17)).

When the snapshot participant 71 receives the notification to notify the completion of the selected transaction processing from the transaction manager 73, the snapshot participant 71 determines the final snapshot time. The copy-on-write is carried out based on this final snapshot time. The copy-on-write will be explained in detail later.

Furthermore, the snapshot participant 71 transmits a snapshot completion notification to the snapshot coordinator 310 (step (18)). It is not shown in FIG. 9A, however, the snapshot completion notification is transmitted to the user terminal from the snapshot coordinator 310. As a result, the user is able to obtain the snapshot data.

After the final snapshot time, the snapshot participant 71 transmits a transaction completion request to the transaction manager 73 in order to complete transactions that are listed in the list of the transactions in progress but not listed in the list of the selected transactions (step (19)). The transaction manager 73 causes the transactions to be completed by transmitting the captured acknowledgement responses (ack) to the transaction coordinator 51, and outputting the captured commit to the transaction participants.

In this way, while the consistency of the data in the overall system is maintained by suitably categorizing transactions according to the states of the transactions and adjusting the commit timing, immediacy by the copy-on-write is enabled by adequately setting the final snapshot time, which is the timing to carry out the copy-on-write.

In order to make it easy to understand the following explanation, the control for delaying the output of the acknowledgement response (ack) and commit is explained using FIG. 9B. As was explained above, when a snapshot request is transmitted at the step (11) from the snapshot coordinator 310 to the snapshot participant 71, the transactions in progress at the temporary snapshot time are identified. Then, the list of the transactions in progress is generated, which is about the states of the transactions in progress, and at the step (14), the list is transmitted from the snapshot participant 71 to the snapshot coordinator 310. After that, at the step (15), the list of the selected transactions is generated and transmitted from the snapshot coordinator 310 to the snapshot participant 71.

As described above, the transaction manager 73 carries out the control for delaying the outputs by capturing the commits and acknowledgement responses of transactions listed in the list of the transactions in progress on and after the temporary snapshot time. In FIG. 9B, a case in which transactions t1 to t3 are executed in the participant node 7 is illustrated, and when the control for delaying the output is not carried out, an acknowledgement response (ack) and commit are output at a timing as illustrated by the dashed line in (a). However, the transaction t1 is not an object of the control for delaying the output, because the commit was already received at the temporary snapshot time. On the other hand, the control for delaying the output is carried out for the transactions t2 and t3, because neither any acknowledgement response nor any commit has been output or transmitted. As will also be described below, here, the result of the transaction t2 can be reflected onto the snapshot, however, the result of the transaction t3 cannot be reflected onto the snapshot. Therefore, it is assumed that the transaction t2 is listed in the list of the selected transactions. In such a case, the processing for the commit is caused to be executed by the transaction t2 by outputting the commit, which was captured and delayed to be outputted, to the transaction t2 (arrow A in FIG. 9B).

After that, after the processing for the commit has been performed for all of the selected transactions included in the list of the selected transactions, the snapshot participant 71 sets the final snapshot time. As a result, at step (18), the snapshot participant 71 transmits a snapshot processing completion notification to the snapshot coordinator 310. Furthermore, at step (19), the snapshot participant 71 outputs a transaction completion request to the transaction manager 73. When the transaction manager 73 receives the transaction completion request, the transaction manager 73 transmits the captured and delayed acknowledgement response (ack), then causes the transactions to execute the subsequent processing (arrow B). As a result, because the transaction coordinator 51 transmits a commit, for example, the commit is received in the process of the transaction t3 as well, and the processing for the commit is carried out.

In this way, by carrying out the copy-on-write based on the final snapshot time after completing the transactions whose processing results are reflected on the snapshot, it is possible to obtain the consistent snapshot data based on the final snapshot time, immediately in the appearance.

In a core system in which updates occur frequently, when a summing processing and analysis processing, which include reference to the database, are simultaneously executed, there is a high possibility of collision. However, by instantaneously obtaining the snapshot and carrying out the summing processing and analysis processing on the obtained snapshot data, it becomes possible to execute both simultaneously without collision.

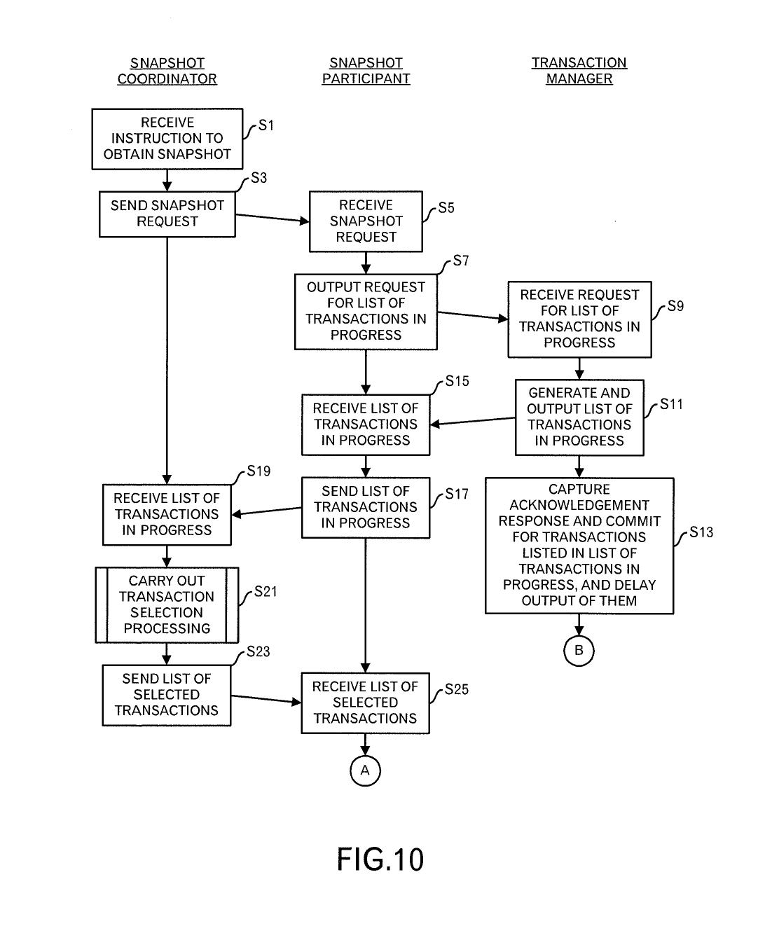

The detailed processing will be explained next using FIG. 10 to FIG. 24.

When the message communication unit 313 of the snapshot coordinator 310 in the coordinator node 3 receives an instruction to obtain the snapshot from the user terminal 9, for example (FIG. 10: step S1), the message communication unit 313 transmits a snapshot request to all of the participant nodes 7 (step S3). It is presumed that the message communication unit 313 knows the addresses and the like for all of the participant nodes 7 in advance. In FIG. 10, for convenience of the explanation, only one participant node 7 is illustrated, however, actually the snapshot request is transmitted to plural participating nodes 7.

When the snapshot participant 71 in the participant node 7 receives the snapshot request (step S5), the snapshot participant 71 outputs a request for a list of transactions in progress to the transaction manager 73 (step S7). The transaction manager 73 receives the request for the list of the transactions in progress from the snapshot participant 71 (step S9), generates the list of the transactions in progress, and outputs the generated list to the snapshot participant 71 (step S11).

As illustrated in FIG. 8, the transaction manager 73 manages the states of the transaction processes 77 that it generated by itself. In a simple case, the list in FIG. 8 may be transmitted as is as the list of the transactions in progress, however, in this embodiment, a transaction having no possibility that the transaction normally completes, or in other words, a transaction that receives the negative acknowledgement response (nack) and abort are removed from the list of the transactions in progress, because the transaction result is not reflected on the snapshot. Moreover, a transaction process 77 that received the commit is also removed, because, after the commit was received, the processing results are immediately reflected on the database 82, and it is clear that the results of the transaction are to be reflected on the snapshot.

Therefore, in a case such as illustrated in FIG. 8, the list of the transactions in progress becomes as illustrated in FIG. 11, for example. Transactions other than the transaction t1 and t3 are transactions for which no notification is required. Therefore, such transactions are removed. Also, as for the states of the transactions t1 and t3, whether it is before or after the acknowledgement response (ack) outputted affects the following processing. Therefore, one of these states is also set for each transaction. Incidentally, the transaction manager 73 also uses the table illustrated in FIG. 8 to manage whether the commit has been received for the transaction. However, whether the transaction received the commit or not may also be managed by the list illustrated in FIG. 11. However, it is sufficient to obtain information representing “before ack outputted” or “after ack outputted”, and when it is the “commit received”, the snapshot coordinator can interpret this as being “after ack outputted”.

Furthermore, after the transactions in progress have been identified, the transaction manager 73 not only captures the acknowledgement response and commit that were outputted or transmitted for the transactions listed in the list of the transactions in progress, but also delays the output or transmission of them (step S13). As was described above, the transaction manager 73 also captures negative acknowledgement responses and aborts, and updates the transaction management table as illustrated in FIG. 8.

On the other hand, when the snapshot participant 71 receives the list of the transactions in progress from the transaction manager 73 (step S15), the snapshot participant 71 transmits the list of the transactions in progress to the snapshot coordinator 310 (step S17).

When the message communication unit 313 of the snapshot coordinator 310 receives the list of the transactions in progress from each of the participant nodes 7 (step S19), the message communication unit 313 stores the received list into the data storage unit 320 in association with the identifiers of the transmission source nodes (or snapshot participants). After the message communication unit 313 receives the list of the transactions in progress from all of the participant nodes 7, the message communication unit 313 notifies the transaction selector 311 of this event.

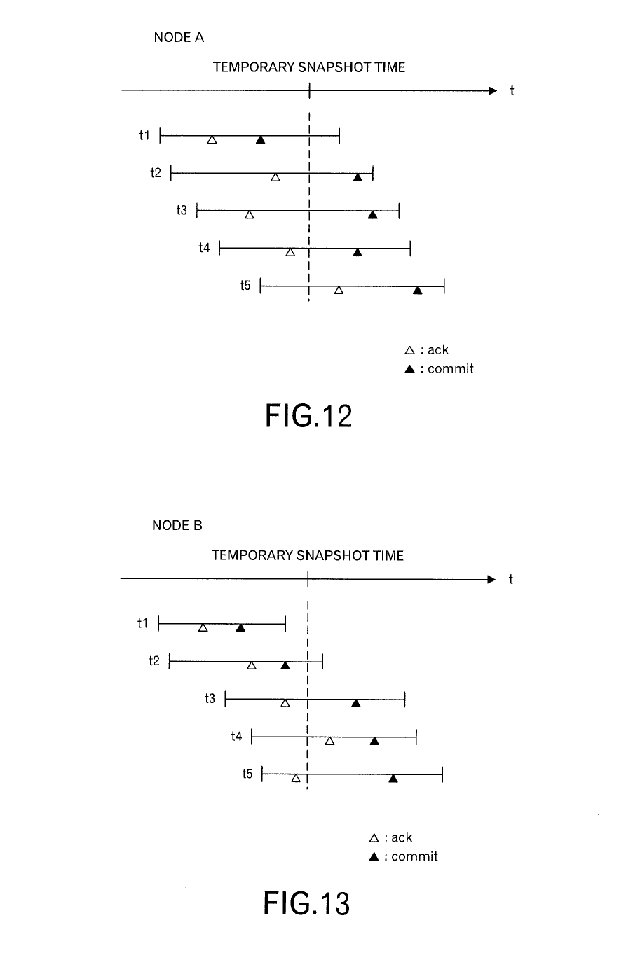

For example, it is assumed that the progress states of transactions in node A are as illustrated in FIG. 12. At the temporary snapshot time, which is the point in time at which the transaction manager 73 identifies the transactions in progress, a commit has been received for transaction t1, acknowledgement responses (ack) have been outputted for transactions t2 to t4, and an acknowledgement response has not yet been outputted for transaction t5. On the other hand, the progress states of transactions in node B are illustrated in FIG. 13. In other words, at the temporary snapshot time, which is the point in time at which the transaction manager 73 identifies the transactions in progress, a commit has been received for transactions t1 and t2, acknowledgement responses (ack) have been outputted for transactions t3 and t5, and an acknowledgement response (ack) has not yet been outputted for transaction t4.

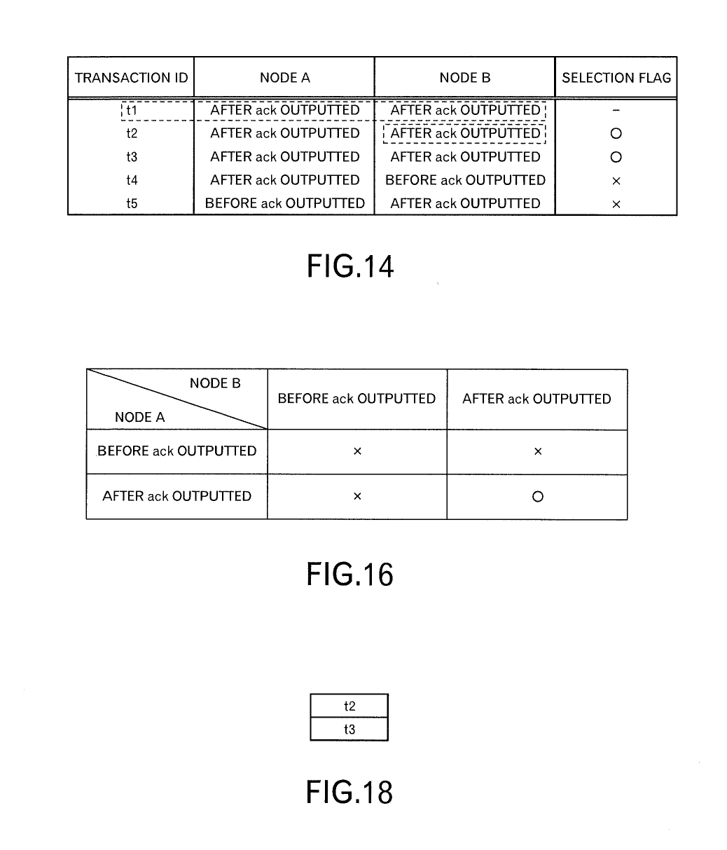

In such a case, a table as illustrated in FIG. 14, for example, is stored in the data storage unit 320. In the example of FIG. 14, the table includes a column of a transaction ID, a column for registering the state of the transaction for each transmission source node ID, and a column of a selection flag. In the example of FIG. 14, it is possible to know, for each transmission source node, the state (before acknowledgement outputted or after acknowledgement outputted) of each transaction, and it is also possible to know, for each transaction, what kind of state the transaction is in, in each transmission source node. Incidentally, at the stage of the step S19, the selection flag is not set.

From the examples in FIG. 12 and FIG. 13, since the commit has been received for transaction t1 in both of the nodes A and B, the transaction t1 is not listed in the list of the transactions in progress. However, in FIG. 14, for convenience of the explanation, it is depicted by being enclosed in a dashed line. As for the transaction t2 as well, since the commit has already been received in the node B, the transaction t2 is not listed in the list of the transactions in progress. However, in FIG. 14, for convenience of the explanation, it is depicted by being enclosed in a dashed line.

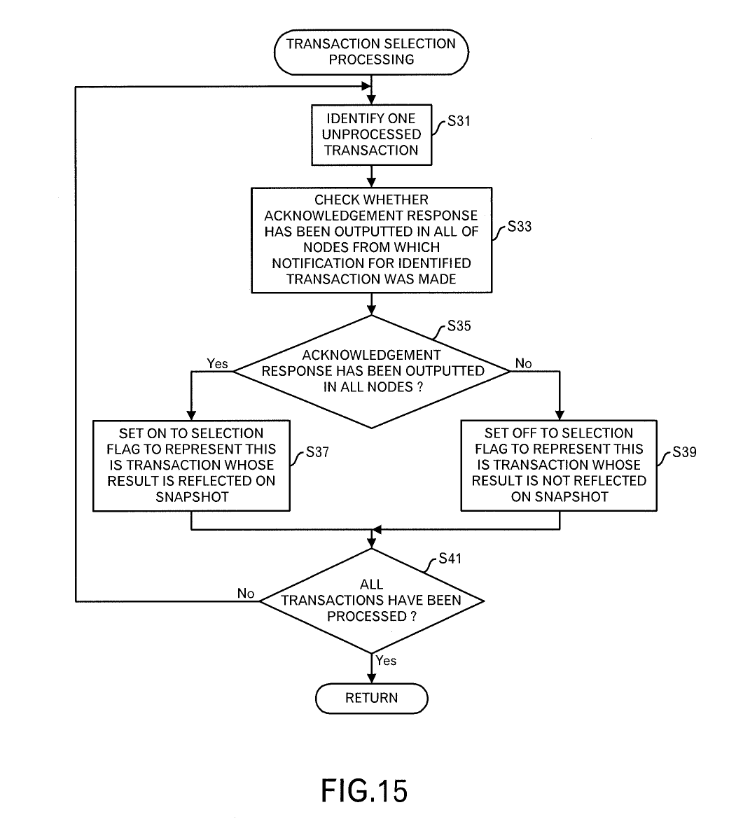

After receiving the notification from the message communication unit 313, the transaction selector 311 carries out a transaction selection processing (step S21). The transaction selection processing will be explained using FIGS. 15 to 18.

The transaction selector 311 identifies one unprocessed transaction (step S31). Then, the transaction selector 311 checks whether or not an acknowledgement response has been outputted in each of the nodes from which the identified transaction is notified by the list of the transactions in progress (step S33). At this step, as illustrated by the examples in FIG. 12 and FIG. 13, an acknowledgement response has been outputted for the transaction t1, however, because a commit has already been received, the transaction t1 is not listed in the list of the transactions in progress. Therefore, the transaction t1 is not checked at the step S31.

As for transaction t2, since the commit has already been received in the node B, the state of the transaction t2 is not represented in the list of the transactions in progress for the node B. In other words, it is not known whether the transaction t2 has been executed in the node B, however, in such a case, only nodes for which the report was received are checked. The reason for this is described below. As for anode in a state before an acknowledgement response is outputted, the output of the acknowledgement response, as will be described below, is delayed until the final snapshot time. Therefore, there is no commit until then. That is, when there is a node in which the commit has already been made, this means that there is no node in the state before an acknowledgement response is outputted. Therefore, all of the states in the list of the transactions in progress must be the states after the acknowledgement response has been outputted, and regardless of the information relating to the committed nodes, the result is finally determined to be included in the snapshot.

When the acknowledgement response has been outputted for the identified transaction in all of the nodes from which the notification was received (step S35: YES route), the transaction selector 311 sets ON to the selection flag in the management table such as illustrated in FIG. 14 (circle in FIG. 14) to represent that this is a transaction whose results will be reflected on the snapshot. Processing then moves to step S41.

On the other hand, when the acknowledgement response has not been outputted in any one of the nodes from which the notification of the identified transaction was made (step S35: NO route), the transaction selector 311 sets OFF to the selection flag in the management table such as illustrated in FIG. 14 (X in FIG. 14) to represent that this is a transaction whose results are not reflected on the snapshot (step S39). Processing then moves to step S41.

To sum up, when there are two nodes, the judgment criteria are as illustrated in FIG. 16. In other words, when the acknowledgement response has already been outputted in both of the nodes, the results of the transaction are reflected on the snapshot, otherwise the results of the transaction are not reflected on the snapshot.

The transaction selector 311 then determines whether or not all transactions have been processed (step S41). Where there is an unprocessed transaction, the processing returns to the step S31, however, when the processing has been completed for all transactions, the processing returns to the calling-source processing.

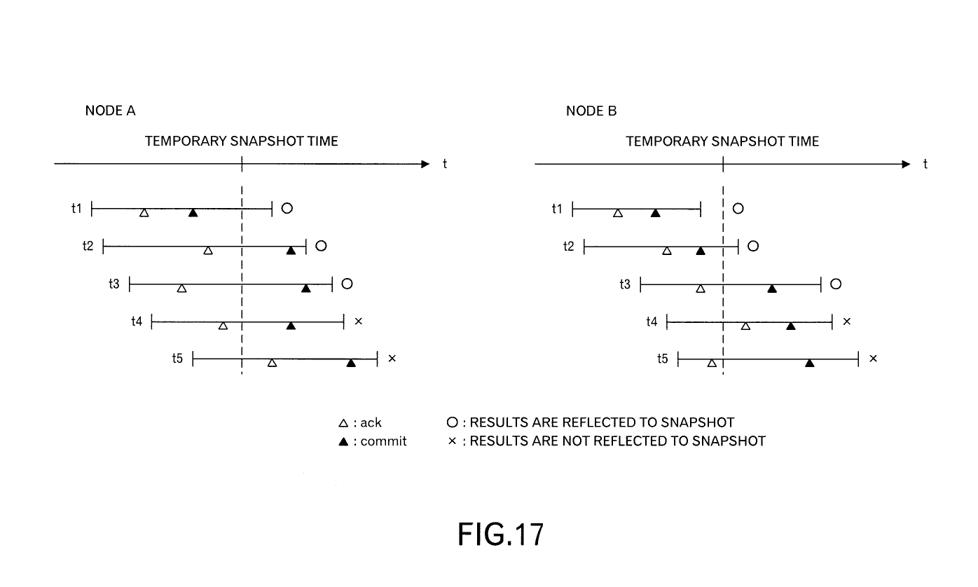

In the example in FIG. 12 and FIG. 13, a judgment result as illustrated in FIG. 17 is obtained. In the nodes A and B, the transactions for which the acknowledgement response has been outputted are transactions t1, t2 and t3, however, as described above, transaction t1 is a transaction that is not listed in the list of the transactions in progress list. Therefore, the transactions t2 and t3 are selected.

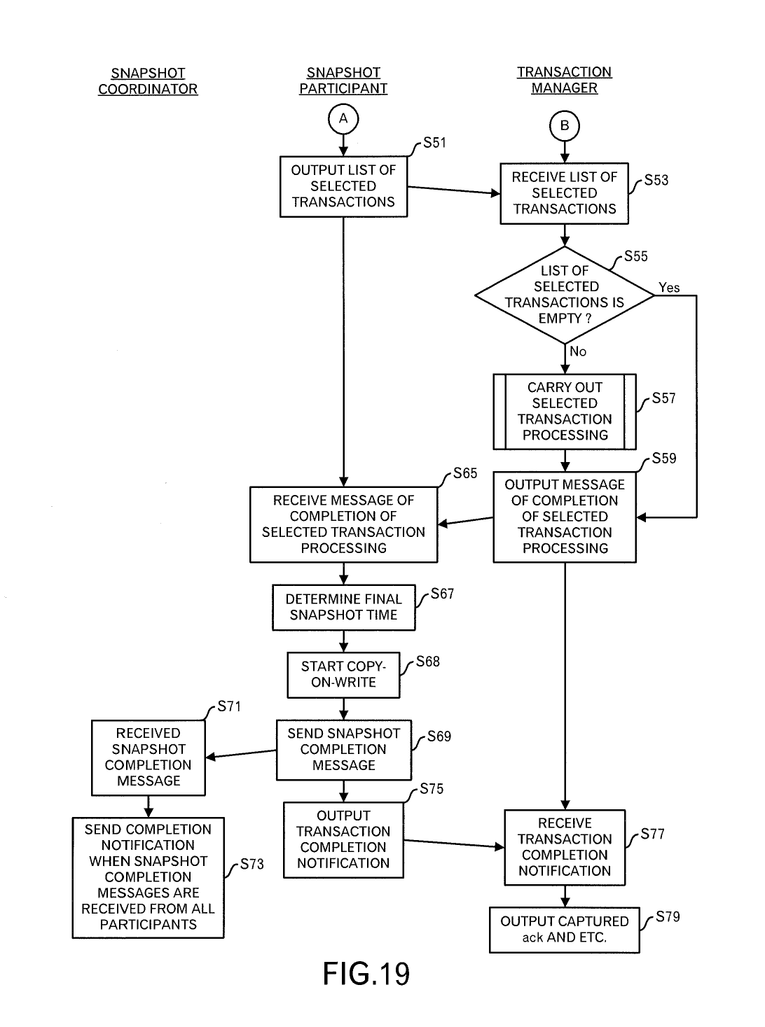

Returning to the explanation of the processing in FIG. 10, the transaction selector 311 outputs the data of the list of the selected transactions to the message communication unit 313, and the message communication unit 313 transmits the list of the selected transactions to all of the participant nodes 7 (step S23). The list of the selected transactions is generated for each node from the table as illustrated in FIG. 14. In the example of FIG. 18, the same list of the selected transactions is generated and transmitted for the node A and node B, however, generally the lists are different. The snapshot participant 71 of the participant node 7 receives the list of the selected transactions from the snapshot coordinator 310 (step S25). Processing then moves to the processing illustrated in FIG. 19 via terminals A and B.

Moving to an explanation of the processing in FIG. 19, the snapshot participant 71 outputs the list of the selected transactions to the transaction manager 73 (step S51). The transaction manager 73 receives the list of the selected transactions from the snapshot participant 71, and stores the list into the data storage unit 75 for example (step S53). The transaction manager 73 then determines whether the list of the selected transactions is empty (step S55). When the list is empty, the processing moves to step S59.

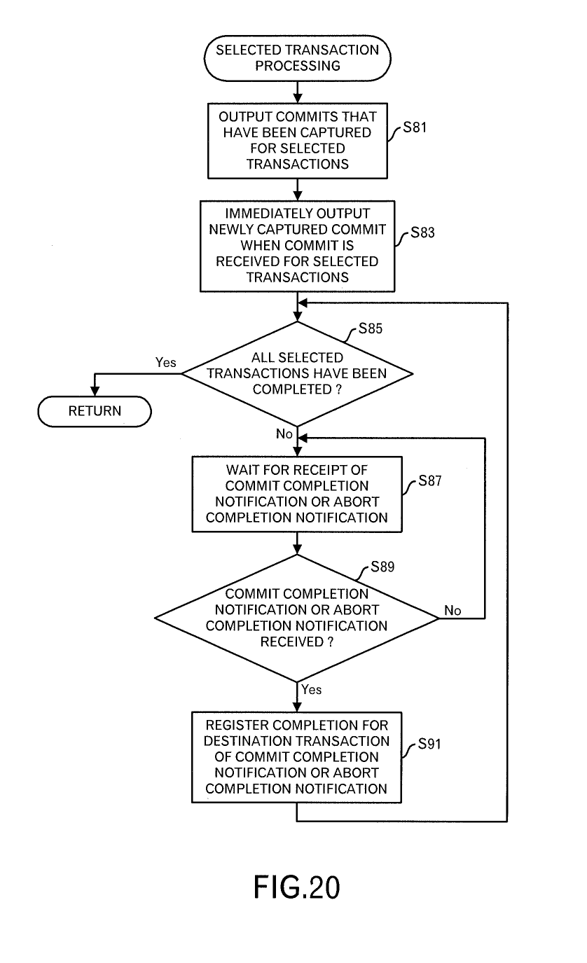

On the other hand, when the list of the selected transactions is not empty, the transaction manager 73 carries out a selected transaction processing (step S57). This selected transaction processing will be explained using FIG. 20.

The transaction manager 73 outputs a commit, which had been captured and delayed for the selected transactions listed in the list of the selected transactions, to the corresponding transaction process 77 (transaction participant) (step S81). In addition, when a commit is newly captured for the selected transactions, the transact ion manager 73 immediately outputs that commit to the corresponding transaction process 77 (step S83).

By doing so, the selected transactions are completed before the final snapshot time is set. As was explained above, when a commit is received, the transaction participant registers, into the log storage unit 81, that the commit was received, then outputs a commit completion notification to the transaction manager 73. After that, the processing results that were stored in the data storage unit 75 are reflected on the database 82. As for an abort, the transaction manager 73 captures it but immediately outputs it without any delay. The transaction manager 73 also manages the states of the transactions in the management table as illustrated in FIG. 8, for example.

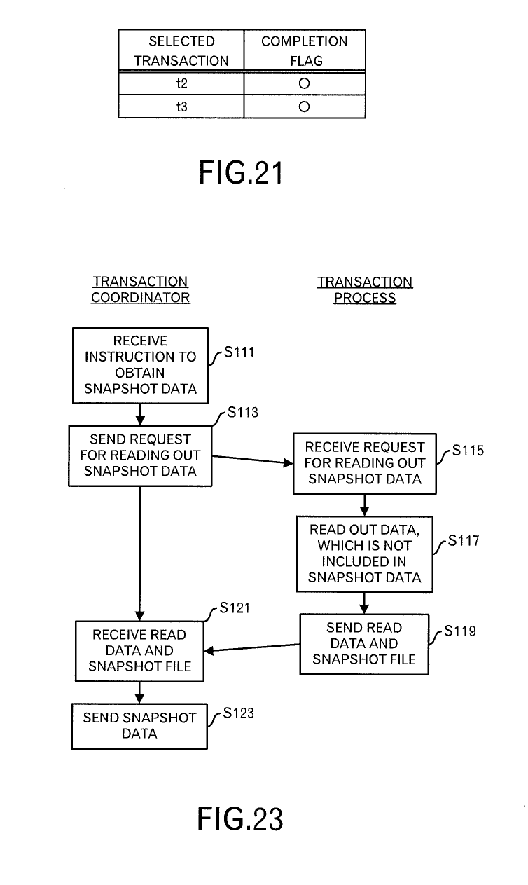

For example, a selected transaction management table as illustrated in FIG. 21 is stored in the data storage unit 75. In the example of FIG. 21, an ID of the selected transaction and completion flag are registered. ON is set to the completion flag when a commit completion notification has been received, or when an abort completion notification has been received. However, because there are transactions that are not executed in this participant node 7 since the transactions have already been aborted, the transaction manager 73 that received the list of the selected transactions references the management table illustrated in FIG. 8, for example, and sets ON to the completion flag for the transactions that are not listed in the management table and transactions for which the abort completion notification has been received. Incidentally, ON may be set to the completion flag for the transactions for which the negative acknowledgement response was received, when the negative acknowledgement response (nack) is captured.

The transaction manager 73 then determines whether all of the selected transactions have been completed (step S85). The transaction manager 73 determines whether ON is set to the completion flag in the selected transaction management table as illustrated in FIG. 21 for all of the selected transactions. Incidentally, a management table may be generated for transactions that are listed in the list of the selected transactions and that are transactions that the transaction manager 73 manages, and in such a case, the transaction manager 73 may determine whether a commit completion notification has been received, or an abort completion notification has been received for all of the transactions listed in this management table.

When it is determined that all of the selected transactions have been completed, the processing returns to the calling-source processing. On the other hand, when there is a selected transaction that is not completed, the transaction manager 73 waits for receipt of a commit completion notification or abort completion notification for that selected transaction (step S87). When a commit completion notification or abort completion notification is not received (step S89: NO route), the processing returns to the step S87. On the other hand, when a commit completion notification or abort completion notification is received for any selected transaction (step S89: YES route), the transaction manager 73 carries out a completion registration in the selected transaction management table for the transmission source transaction of the commit completion notification or abort completion notification (step S91). In other words, ON is set to the completion flag. After that, the processing returns to the step S85.

In this way, the transaction manager 73 confirms that the selected transactions that are listed in the list of the selected transactions are completed in its own participant node 7.

Returning to the explanation of the processing in FIG. 19, the transaction manager 73 outputs a message to notify the completion of the selected transaction processing to the snapshot participant 71 after the step S57 (step S59). Incidentally, as for moving from the step S55 to the step S59, because there is no need to check the completion of the transactions, the message of the completion of the selected transaction processing is immediately outputted.

The snapshot participant 71 receives the message to notify the completion of the selected transaction processing from the transaction manager 73 (step S65). Here, because the snapshot participant 71 has completed preparation to carry out the copy-on-write, the snapshot participant 71 determines the final snapshot time at this time (step S67).

The snapshot participant 71 then causes the copy-on-write processing unit 79 to start the copy-on-write (step S68). For example, the snapshot participant 71 generates a snapshot file in the data storage unit 75. By doing so, when the transaction process 77 carries out the next update of data (for example, data in page or record units) in the database 82, the copy-on-write processing unit 79 copies the data before the update and stores the copied data into the data storage unit 75, for example. Thus, in the appearance, acquisition of the snapshot is completed instantly. However, the actual snapshot is gradually stored in the data storage unit 75 every time an update is carried out.

After that, the snapshot participant 71 transmits a snapshot completion message to the snapshot coordinator 310 of the coordinator node 3 (step S69). The message communication unit 313 of the snapshot coordinator 310 receives the snapshot completion message from the snapshot participant 71 (step S71). After that, when snapshot completion messages have been received from all of the participant nodes 7, the message communication unit 313 of the snapshot coordinator 310 transmits completion notification to the user terminal 9 or the like (step S73).

When the user terminal 9 or the like receives the completion notification, it becomes possible to request the snapshot data after that.

On the other hand, the snapshot participant 71 outputs a transaction completion request to the transaction manager 73 (step S75). The transaction manager 73 receives the transaction completion request from the snapshot participant 71 (step S77). Here, the transaction manager 73 transmits or outputs acknowledgement responses and commits that were captured and delayed for transactions that are not listed in the list of the selected transactions but are listed in the list of the transactions in progress (step S79). As a result, when the transaction process 77 receives the commit, the processing results that were written in the log are reflected on the database 82. However, at this time, the copy-on-write processing unit 79 copies the data before being updated and stores the read data into the snapshot file in the data storage unit 75.

After that, until the snapshot participant 71 actually reads the snapshot data, when the transaction process 77 updates the database 82, the copy-on-write processing unit 79 copies the data before being updated and stores that data into the data storage unit 75, as long as the data has not already been copied. By repeating such a process, the snapshot data is gradually stored into the snapshot file in the data storage unit 75.

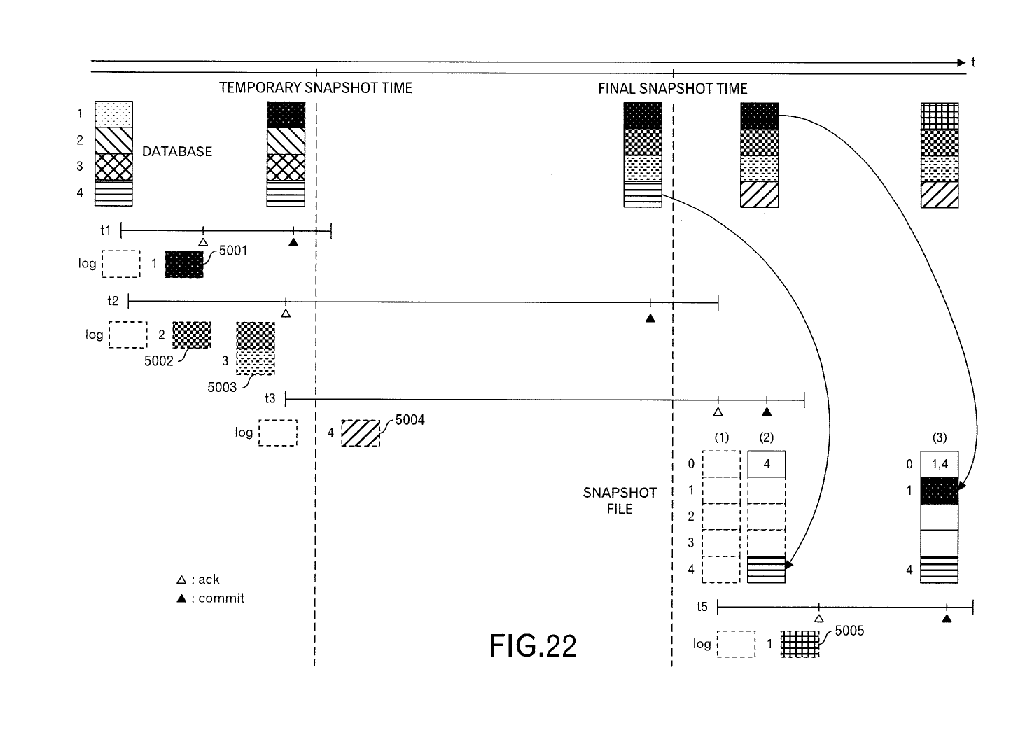

Here, update of the database 82 and change in the snapshot file will be explained using FIG. 22. In FIG. 22, although transactions in another node are not described, the states in any nodes for any transactions are the same as illustrated in FIG. 22. For example, in FIG. 22, the transaction t1 is already committed, so it is committed in another node as well. As for the transaction t2, an acknowledgement response has already been outputted at the temporary snapshot time, so an acknowledgement response is also outputted in another node. The same is true for t3 and t5 as well. In the example of FIG. 22, there are four pages in the database 82, and the transaction t1 updates page 1, the transaction t2 updates pages 2 and 3, and the transaction t3 updates page 4. In the transaction t1, as the processing advances, update data 5001 is generated for the page 1, the data is stored in the data storage unit 75, and an acknowledgement response is transmitted. After that, when the commit is received, the page 1 of the database 82 is updated with the update data 5001. As for the transaction t1, because a commit is transmitted before the temporary snapshot time, the processing result is reflected on the snapshot. On the other hand, as for transaction t2, as processing advances, update data 5002 is generated for the page 2 and stored in the data storage unit 75, and as processing further advances, update data 5003 is generated for the page 3 and stored in the data storage unit 75. Then, because time reaches the temporary snapshot time after the acknowledgement response has been transmitted, the transaction manager 73 captures the commit and delays the output of the commit. However, as for transaction t2, because an ack has been transmitted, the transaction is a transaction whose processing results are reflected on the snapshot, and because a commit is transmitted before the final snapshot time, the database 82 is immediately updated with the update data 5002 and 5003 after that.

After the final snapshot time, the snapshot file is generated in the data storage unit 75. As illustrated by the example in FIG. 22, the snapshot file is a file that initially (at timing (1)) has a size of “0”, and this reduces the used capacity of the data storage unit 75. Incidentally, the snapshot file has a header that stores IDs of the copied pages, and also stores copies of each page.

As for the transaction t3, as processing advances, update data 5004 is generated for the page 4 and stored in the data storage unit 75, however, the time reaches the temporary snapshot time before an acknowledgement response is transmitted. Therefore, the transaction manager 73 captures the acknowledgement response and delays the output of the acknowledgement response. The time reaches the temporary snapshot time before the acknowledgement response is transmitted, so the processing results are not reflected on the snapshot, and after the time reaches the final snapshot time, the acknowledgement response is released, and for example, a commit is also outputted. By doing so, after the commit is received, the database 82 is updated with the update data 5004. At this time, the copy-on-write is executed, and the data for the page 4 before being updated with the update data 5004 is stored in the snapshot file. The ID “4” of the copied page is also registered in the header.

After that, the transaction t5 is executed, update data 5005 for the page 1 is generated and stored in the data storage unit 75, and after a commit is outputted, the data of the page 1 in the database 82 is updated with the update data 5005. Here, because the page 1 is not registered in the header of the snapshot file, the copy-on-write is performed, and the data for the page 1 before being updated with update data 5005 is stored. The ID “1” of the copied page is also registered in the header.

By repeating such a processing, the snapshot data is stored in the snapshot file.

The processing that is carried out after that when a request to obtain the snapshot data is outputted from the user terminal 9 to the transaction coordinator node 5, for example, will be explained using FIG. 23. First, a processing to transmit all of the snapshot data to the user terminal will be explained. When the transaction coordinator 51 receives an instruction to obtain the snapshot data (step S111), the transaction coordinator 51 transmits a request for reading out the snapshot data to the transaction process 77 of each node (step S113). It is assumed that the transaction process 77 has been generated before this by the transaction manager 73. When the transaction process 77 of each node receives the request for reading out the snapshot data from the transaction coordinator 51 (step S115), the transaction process 77 reads out, from the database 82, data that is not included in the snapshot file (step S117). As for the data that is not included in the snapshot file, the IDs of the pages that have not been copied can be obtained by checking the header. When the step S117 is completed, the transaction process 77 transmits the data that was read at the step S117 and the data read from the snapshot file to the transaction coordinator 51 (step S119).

The transaction coordinator 51 receives the data read from the database 82 and the data read from the snapshot file from the transaction process 77, and stores the data in the data storage unit 52 (step S121). When the transaction coordinator 51 receives data from all of the nodes, the transaction coordinator 51 transmits all of the snapshot data to the requesting source user terminal 9 (step S123). Incidentally, since the amount of data may become very large, data that represents the storage location of the transaction coordinator node 5 (for example, URI (Universal Resource Indicator)) may be sent as a notification to the user terminal 9, so that the user terminal 9 may download the data. Also, instead of outputting all of the snapshot data together, the data may be divided into plural portions or the data satisfying certain conditions as in the case of a normal database may be outputted in response to a request to return such data.

In this way, the user terminal 9 obtains snapshot data, and may perform analysis or summing of the obtained data. Analysis or summing of the snapshot data may also be partially executed by the transaction process at each node without returning the data to the user terminal 9 (for example, sums can be found at each node), and the results can then be returned to the user terminal 9, after which analysis and summing can be performed at the user terminal (for example the total of the sums found at each node can be calculated).

The explanation up to this point has centered on transactions that normally complete. Here, a supplementary explanation will be given for a case in which a transaction cannot normally complete, because of an error that occurred at a transaction participant, or an error that occurred at another transaction participant or transaction coordinator.

As described above, when it is clear that a transaction will not complete normally (for example, the negative acknowledgement response is transmitted, or the abort is received), the transaction is not listed in the list of the transactions in progress. This is not a problem for the following reason.

In other words, in the case of a transaction for which an error occurred, an abort is finally received and the transaction is cancelled. That is, the transaction is not included in the snapshot, and in that sense, basically no problem will occur. However, when an error occurs at a different transaction participant, and the transaction is not listed in the list of the transactions in progress, there is a possibility that the transaction will be set to be included in the snapshot. However, in that case, the transaction is finally aborted, so the result is not included in the snapshot. When the transaction is aborted, transmission is not delayed, so the processing does not stall. Therefore, there is no problem.

Although the embodiments were explained, this technique is not limited to these embodiments. For example, the functional block diagram illustrated in FIG. 2 is a mere example, and does not always correspond to actual program module configuration. In addition, the storage mode of the data is also a mere example. Moreover, instead of the user terminal 9, other functions in the network may request the snapshot.

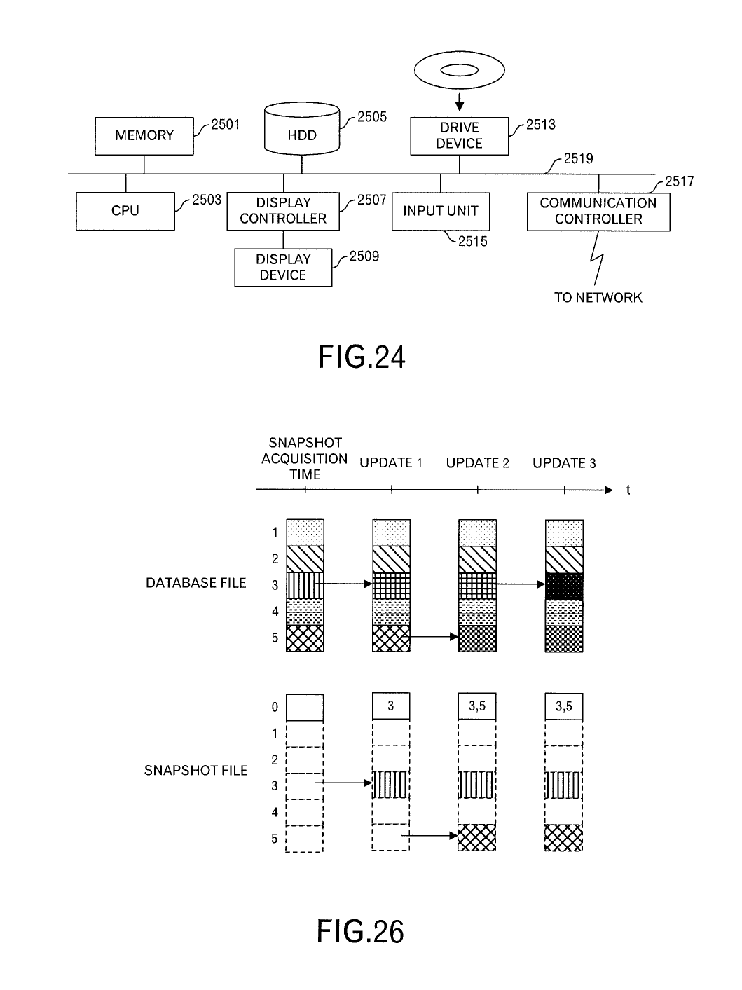

In addition, the user terminal 9, the coordinator node 3, the participant node 7 and the transaction coordinator node 5 are computer devices as shown in FIG. 24. That is, a memory 2501 (storage device), a CPU 2503 (processor), a hard disk drive (HDD) 2505, a display controller 2507 connected to a display device 2509, a drive device 2513 for a removable disk 2511, an input device 2515, and a communication controller 2517 for connection with a network are connected through a bus 2519 as shown in FIG. 24. An operating system (OS) and an application program for carrying out the foregoing processing in the embodiment, are stored in the HDD 2505, and when executed by the CPU 2503, they are read out from the HDD 2505 to the memory 2501. As the need arises, the CPU 2503 controls the display controller 2507, the communication controller 2517, and the drive device 2513, and causes them to perform necessary operations. Besides, intermediate processing data is stored in the memory 2501, and if necessary, it is stored in the HDD 2505. In this embodiment of this invention, the application program to realize the aforementioned functions is stored in the removable disk 2511 and distributed, and then it is installed into the HDD 2505 from the drive device 2513. It may be installed into the HDD 2505 via the network such as the Internet and the communication controller 2517. In the computer as stated above, the hardware such as the CPU 2503 and the memory 2501, the OS and the necessary application programs systematically cooperate with each other, so that various functions as described above in details are realized.

More specifically, functions such as the snapshot coordinator 310, transaction coordinator 51, snapshot participant 71, transaction manager 73, and copy-on-write processing unit 79 may be realized by executing, by the CPU 2503, the programs. In addition, the HDD 2505 and memory 2501 are used to realize at least a portion of the data storage unit 320, data storage unit 75, log storage unit 81 and database 82.

Just to be sure, the three-phase commit protocol and copy-on-write will be supplementary explained.

(A) Three-Phase Commit Protocol

In the two-phase commit protocol, when a coordinator is failed before a participant receives the commit and after the participant transmits an acknowledgement response, a state that the commit and abort cannot be made, so-called “blocking”, occurs. In order to solve such a problem, the three-phase commit protocol is considered.

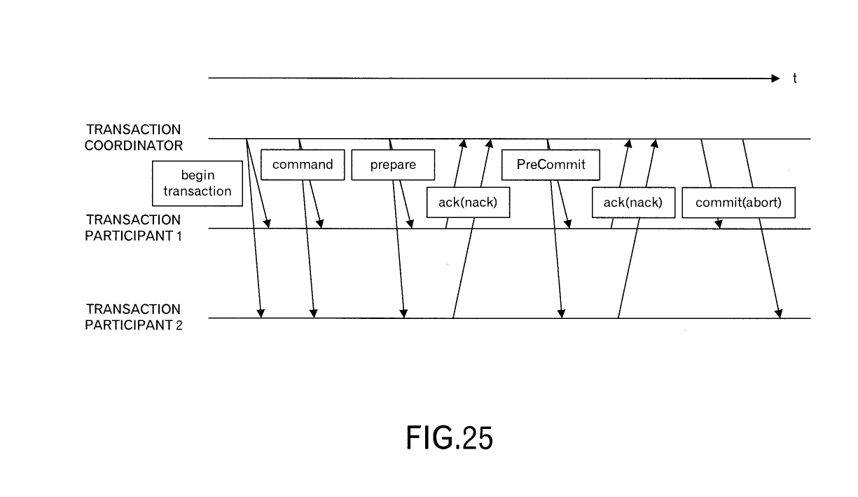

The difference with the two-phase commit protocol is that, after exchanging “prepare” and “ack” as illustrated in FIG. 25, “preCommit” and “ack” are further exchanged. By executing such an exchange, namely, receiving “preCommit”, it is possible for all participants to know a state that processing in all participants has normally completed and the transaction can be committed. After that, the commit is actually made. By exchanging “preCommit” and “ack”, it becomes possible to avoid the blocking due to the node failure, although the detailed explanation is omitted.

Incidentally, the exchange of the final ack (not “ack” after “prepare”) and commit is related to this embodiment, as well as the two-phase commit protocol.

In addition, the writing of logs concerning “ack” and “commit” is similar to the two-phase commit protocol.

(B) Copy-on-Write

Here, the relationship between the concentrated copy-on-write and data update will be explained based on the storage structure in page unit. The page is a memory block having a fixed length, such as 4 KB or 8 KB, and is a unit for input and output to a disk device. However, instead of page unit, record unit may be used.

As illustrated in FIG. 26, it is assumed that a database file includes 5 pages. The number on the left side is a page number.

At the snapshot acquisition time, a snapshot file that is a file to store the snapshot data is prepared. Information representing what page was updated after the snapshot is stored in page 0 of this file. It is assumed that pages 1 to 5 of the snapshot file respectively correspond to pages with the same number in the database file. However, at the snapshot acquisition time, these areas are not allocated and empty.

At update time 1 after the snapshot acquisition time, it is assumed that the page 3 in the database file is updated. Then, before the page in the page 3 is updated, its contents are copied into the page 3 in the snapshot file.

After that, the page 3 of the database file is updated. The arrows in the figure represent the update.

At update time 2, it is assumed that the page 5 in the database file is updated. Also at this time, like the page 3, the page 5 of the database file is updated after a copy is stored to the page 5 of the snapshot file.

It is also assumed that, at update time 3, the page 3 is updated again. At this time, although the database file is updated, a page before the update is not copied to the snapshot file. This is because the contents at the snapshot acquisition time have already been stored in the snapshot file, and it is not required to copy the contents. If the contents are further copied, information at the snapshot acquisition time is lost.

Next, reference to the page will be explained. As for pages that are not updated after the snapshot, page in the database file is referenced, and as for pages that were updated, the page in the snapshot file is referenced. For example, at and after the update time 2, as for the pages 3 and 5, the snapshot file is referenced, and as for pages other than them, the database file is referenced. It is possible to judge which file should be referenced, based on information in the page 0 in the snapshot file.

Thus, in this copy-on-write method, at the snapshot acquisition time, it is enough only by preparing a file, which is almost empty. Therefore, it is possible to immediately obtain the snapshot. However, because the actual copy is delayed and performed at the update, the processing amount for the update processing increases by the processing amount of the copy. In addition, when all pages are updated after the snapshot acquisition time, the almost same storage area as the database file is required similarly to a processing to copy at the snapshot acquisition time.

The aforementioned embodiments are outlined as follows:

A snapshot acquisition processing method executed by a computer that is a snapshot participant node includes: (A) in response to receipt of a snapshot request from a first node that receives an instruction to obtain a snapshot, identifying transactions in progress; (B) transmitting data representing states of the identified transactions in progress to the first node; (C) after the identifying, carrying out a first processing to prevent the transactions in progress from normally completing; (D) receiving a list of first transactions whose results are reflected to snapshot data or a list of second transactions whose results are not reflected to the snapshot data; and (E) causing to execute copy-on-write on a basis of a specific time after removing the first transactions from among transactions to be processed in the first processing and confirming that the respective first transactions are normally completed or cancelled.

Thus, when the transactions having a possibility that the processing result is reflected to the snapshot are made successfully complete or cancelled by a specific time and the copy-on-write is carried out on a basis of the specific time, it becomes possible to immediately obtain the consistent snapshot. Incidentally, when there are a lot of first transactions, the communication amount may be reduced by employing the list of the second transactions.

Incidentally, the aforementioned first processing may include a processing to prevent from receiving a commit, and the aforementioned causing may include outputting the commit whose receiving was prevented to a process for the first transactions. It is possible to handle a case of a protocol in which a commit is outputted in response to an acknowledgement response, such as two-phase commit protocol.

In addition, the transactions in progress may be defined by excluding a transaction that has outputted a negative acknowledgement response and a transaction that has received an abort from transactions that have not received the commit. By limiting to the transactions having a possibility that the results are reflected onto the database or the like, the processing load of the snapshot coordinator is reduced.

Furthermore, the aforementioned first processing may further include a processing to prevent from transmitting an acknowledgement response from a transaction that has not received the commit. In such a case, the method may further include: after the specific time, transmitting the acknowledgement response whose transmitting is prevented to a transaction coordinator; and after the specific time, causing the second transactions to execute a normal completion or cancellation. Thus, it becomes possible to surely not include the processing results of the second transactions into the snapshot.

Furthermore, the aforementioned transmitting may include storing a second list of identifiers of the identified transactions in progress into a data storage unit. Moreover, the aforementioned first processing may include, based on the second list stored in the data storage unit, preventing the transactions in progress from normally completing. In addition, the aforementioned receiving may include: storing the list received from the first node into the data storage unit; and checking, based on the list received from the first node and stored in the data storage unit, whether the respective first transactions have completed or cancelled. Thus, the processing is surely carried out.

A snapshot acquisition processing method executed by a computer that is a snapshot coordinator node includes: (A) in response to receipt of an instruction to obtain a snapshot, transmitting a snapshot request to each of a plurality of first nodes; (B) receiving, from each of the plurality of first nodes, identifiers of transactions in progress and data representing states of the transactions in progress, and storing the received identifiers and the received data into a data storage unit in association with a transmission source node; (C) identifying first transactions for which an acknowledgement response has been outputted in each of relating transmission source nodes from among the transactions whose identifiers are stored in the data storage unit; and (D) transmitting a list of the identified first transactions or a list of second transactions that are transactions other than the identified first transactions among the transactions whose identifiers are stored in the data storage unit. Incidentally, the list may be generated for each participant node.

Incidentally, it is possible to create a program causing a computer to execute the aforementioned processing, and such a program is stored in a computer readable storage medium or storage device such as a flexible disk, CD-ROM, DVD-ROM, magneto-optic disk, a semiconductor memory, and hard disk. In addition, the intermediate processing result is temporarily stored in a storage device such as a main memory or the like.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. A computer-readable, non-transitory storage medium storing a program for causing a computer to execute a process comprising:
in response to receipt of a snapshot request from a first node that receives an instruction to obtain a snapshot, identifying transactions in progress;
transmitting data representing states of the identified transactions in progress to the first node;
after the identifying, carrying out a first processing to prevent the transactions in progress from normally completing;
receiving a list of first transactions whose results are reflected to snapshot data or a list of second transactions whose results are not reflected to the snapshot data; and
causing to execute copy-on-write on a basis of a specific time after removing the first transactions from among transactions to be processed in the first processing and confirming that the respective first transactions are normally completed or cancelled.

2. The computer-readable, non-transitory storage medium as set forth in claim 1, wherein the first processing comprises a processing to prevent from receiving a commit, and the causing comprises outputting the commit whose receiving was prevented to a process for the first transactions.

3. The computer-readable, non-transitory storage medium as set forth in claim 2, wherein the transactions in progress are defined by excluding a transaction that has outputted a negative acknowledgement response and a transaction that has received an abort from transactions that have not received the commit.

4. The computer-readable, non-transitory storage medium as set forth in claim 2, wherein the first processing further includes a processing to prevent from transmitting an acknowledgement response from a transaction that has not received the commit, and
the process further comprises:
after the specific time, transmitting the acknowledgement response whose transmitting is prevented to a transaction coordinator; and
after the specific time, causing the second transactions to execute a normal completion or cancellation.

5. The computer-readable, non-transitory storage medium as set forth in claim 1, wherein the transmitting includes storing a second list of identifiers of the identified transactions in progress into a data storage unit,
the first processing includes, based on the second list stored in the data storage unit, preventing the transactions in progress from normally completing, and
the receiving includes:
storing the list received from the first node into the data storage unit; and
checking, based on the list received from the first node and stored in the data storage unit, whether the respective first transactions have completed or cancelled.

6. A computer-readable, non-transitory storage medium storing a program for causing a computer to execute a process comprising:
in response to receipt of an instruction to obtain a snapshot, transmitting a snapshot request to each of a plurality of first nodes;
receiving, from each of the plurality of first nodes, identifiers of transactions in progress and data representing states of the transactions in progress, and storing the received identifiers and the received data into a data storage unit in association with a transmission source node;
identifying first transactions for which an acknowledgement response has been outputted in each of relating transmission source nodes from among the transactions whose identifiers are stored in the data storage unit; and
transmitting a list of the identified first transactions or a list of second transactions that are transactions other than the identified first transactions among the transactions whose identifiers are stored in the data storage unit.

7. An information processing method comprising:
in response to receipt of a snapshot request from a first node that receives an instruction to obtain a snapshot, identifying, by a computer, transactions in progress;
transmitting, by the computer, data representing states of the identified transactions in progress to the first node;
after the identifying, carrying out, by the computer, a first processing to prevent the transactions in progress from normally completing;
receiving, by the computer, a list of first transactions whose results are reflected to snapshot data or a list of second transactions whose results are not reflected to the snapshot data; and
executing, by the computer, copy-on-write on a basis of a specific time after removing the first transactions from among transactions to be processed in the first processing and confirming that the respective first transactions are normally completed or cancelled.

8. An information processing method comprising:
in response to receipt of an instruction to obtain a snapshot, transmitting, by a computer, a snapshot request to each of a plurality of first nodes;
receiving, from each of the plurality of first nodes, by the computer, identifiers of transactions in progress and data representing states of the transactions in progress, and storing the received identifiers and the received data into a data storage unit in association with a transmission source node;
identifying, by the computer, first transactions for which an acknowledgement response has been outputted in each of relating transmission source nodes from among the transactions whose identifiers are stored in the data storage unit; and
transmitting, by the computer, a list of the identified first transactions or a list of second transactions that are transactions other than the identified first transactions among the transactions whose identifiers are stored in the data storage unit.

9. A computer comprising:
a data storage unit;
a participant processing unit to receive a snapshot request from a first node that receives an instruction to obtain a snapshot; and
a transaction manager to identify transactions in progress and to generate data representing states of the identified transactions in progress, and
wherein the participant processing unit transmits the generated data to the first node,
the transaction manager carries out a first processing to prevent the transactions in progress from normally completing after the transactions in progress were identified, and
the participant processing unit receives a list of first transactions whose results are reflected to snapshot data or a list of second transactions whose results are not reflected to the snapshot data, and to store the received list into the data storage unit, and to causes to execute copy-on-write on a basis of a specific time after removing the first transactions from among transactions to be processed in the first processing and confirming that the respective first transactions are normally completed or cancelled.

10. A computer comprising:
a data storage unit;
a communication unit to transmit, in response to receipt of an instruction to obtain a snapshot, transmitting, a snapshot request to each of a plurality of first nodes, and to receive, from each of the plurality of first nodes, identifiers of transactions in progress and data representing states of the transactions in progress, and to store the received identifiers and the received data into the data storage unit in association with a transmission source node; and
a transaction selector to select first transactions for which an acknowledgement response has been outputted in each of relating transmission source nodes from among the transactions whose identifiers are stored in the data storage unit, and
wherein the communication unit transmits a list of the identified first transactions or a list of second transactions that are transactions other than the identified first transactions among the transactions whose identifiers are stored in the data storage unit.
